(19) United States
(12) Patent Application Publication
(10) Pub. No.: US 2019/0296814 A1
(43) Pub. Date: Sep. 26, 2019

(54) METHOD OF CONSTRUCTING CODEBOOK AND USER EQUIPMENT

(71) Applicants: DOCOMO INNOVATIONS, INC., Palo Alto, CA (US); NTT DOCOMO, INC., Tokyo (JP)

(72) Inventors: Yuichi Kakishima, Tokyo (JP); Chongning Na, Tokyo (JP); Huiling Li, Tokyo (JP); Huiling Jiang, Tokyo (JP); Satoshi Nagata, Tokyo (JP)

(73) Assignee: NTT DOCOMO, INC., Tokyo (JP)

(21) Appl. No.: 16/349,494

(22) PCT Filed: Nov. 13, 2017
(86) PCT No.: PCT/US2017/061271

§ 371 Date: May 13, 2019

Related U.S. Application Data
(60) Provisional application No. 62/420,859, filed on Nov. 11, 2016.

(51) Int. Cl. H04B 7/06; H04B 7/0417; H04B 7/0456

(52) U.S. Cl. CPC H04B 7/0626; H04B 7/0486; H04B 7/0417

(57) ABSTRACT

A method of constructing a codebook with multiple resolution in a wireless communication system includes constructing, with a user equipment (UE), a high resolution codebook using a low resolution codebook, and transmitting, from the UE to a base station (BS), normal Channel State Information (CSI) feedback or advanced CSI feedback based on an instruction from the BS or determination in the UE. The normal CSI feedback includes CSI generated based on the low resolution codebook. The advanced CSI feedback includes CSI generated based on the high resolution codebook. The low resolution codebook reuses beams selected based on a beam selection scheme under a Long Term Evolution (LTE) standard. The high resolution codebook is a high resolution codebook for rank 2. The high resolution codebook reuses a 1-layer codebook of a LTE standard or one of 3-layer, 5-layer, and 7-layer codebook of the LTE standard.

### TECHNICAL FIELD

The present invention generally relates to a method of constructing a codebook with multiple resolution and a user equipment in a wireless communication system.

### BACKGROUND ART

A New Radio (NR; fifth generation (5G) radio access technology) system operates in higher frequency bands (e.g., Millimeter Wave (mmWave)). In the NR system using the mmWave, transmission and reception beam selection greatly affects system characteristics.

In the NR system, transmission and reception beams are determined using beam management and channel state information (CSI) acquisition. Typically, a long-term (periodic) and wideband beam may be determined in the beam management, and then, a short-term (triggered) and narrow band beam may be determined in the CSI acquisition scheme.

In the 3rd Generation Partnership Project (3GPP) Radio Access Network (RAN) Working Group (WG), it is agreed that two types of codebook design are used in the CSI acquisition. One is a low resolution codebook which is constructed by a single beam selection scheme. In the single beam selection scheme, a single beam is selected from multiple beams. The other is a high resolution codebook which is constructed by a beams combination scheme. In the beams combination scheme, a combination of at least two beams is selected from multiple beams. CSI reporting for the beams combination scheme is called advanced CSI reporting.

Conventional methods of constructing the high resolution codebook are not compatible to a legacy Long Term Evolution (LTE) codebook or do not allow the reuse of the legacy LTE codebook, with either non-orthogonal or constrained DFT beams. Thus, how the high resolution codebook should be constructed has not been determined in the 3GPP RAN WG. Furthermore, how CSI feedback design for the normal CSI reporting and the advanced CSI reporting has not been determined.

### Non-Patent Reference

[Non-Patent Reference 1] 3GPP, TS 36.211 V 14.4.0
[Non-Patent Reference 2] 3GPP, TS 36.213 V 14.4.0

### SUMMARY OF THE INVENTION

One or more embodiments of the present invention relate to a method of constructing a codebook with multiple resolution in a wireless communication system including constructing, with a user equipment (UE), a high resolution codebook using a low resolution codebook, and transmitting, from the UE to a base station (BS), normal Channel State Information (CSI) feedback or advanced CSI feedback based on an instruction from the BS or determination in the UE. The normal CSI feedback includes CSI generated based on the low resolution codebook. The advanced CSI feedback includes CSI generated based on the high resolution codebook.

One or more embodiments of the present invention relate to a user equipment (UE) including a processor that constructs a high resolution codebook using a low resolution codebook, and a transmitter that transmits, to a BS, normal CSI feedback or advanced CSI feedback based on an instruction from the BS or determination in the UE. The normal CSI feedback includes CSI generated based on the low resolution codebook. The advanced CSI feedback includes CSI generated based on the high resolution codebook.

Other embodiments and advantages of the present invention will be recognized from the description and figures.

### BRIEF DESCRIPTION OF THE DRAWINGS

FIG. 1 is a diagram showing a configuration of a wireless communication system according to one or more embodiments of the present invention.

FIG. 2A is a diagram to explain a low (normal) resolution codebook according to one or more embodiments of the present invention.

FIG. 2B is a diagram to explain a high resolution codebook according to one or more embodiments of the present invention.

FIGS. 3A and 3B are diagrams showing an example of a method of selecting high resolution beams according to one or more embodiments of the present invention.

FIG. 4 is a diagram showing an example relating to candidate beam patterns for two beams combination for each layer.

FIG. 5 is a diagram showing an example relating to candidate beam patterns for three beams combination for each layer.

FIG. 6 is a diagram showing an example relating to candidate beam patterns for four beams combination for each layer.

FIG. 7 is a diagram showing an example of advanced CSI reporting triggered by a BS according to one or more embodiments of the present invention.

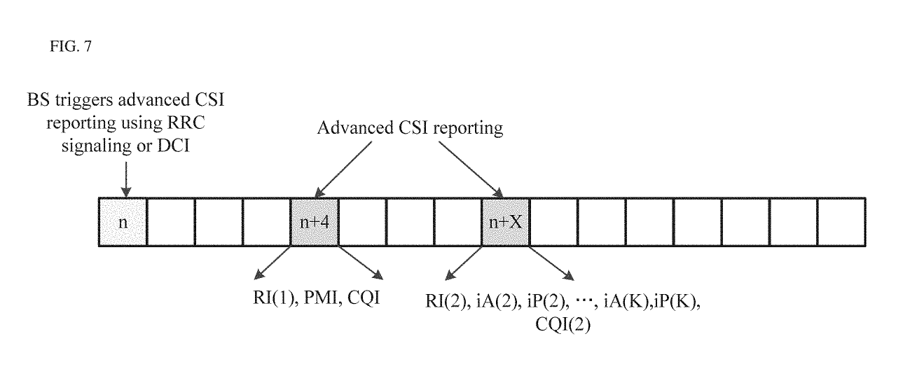

FIG. 8 is a diagram showing an example of advanced CSI reporting triggered by a UE according to one or more embodiments of the present invention.

### DETAILED DESCRIPTION OF EMBODIMENTS

Embodiments of the present invention will be described in detail below, with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

In one or more embodiments of the present invention, a low resolution codebook may be referred to as a normal resolution codebook, or a Type I codebook and a high resolution codebook may be referred to as an advanced codebook or a Type II codebook. In one or more embodiments of the present invention, low resolution CSI and low resolution (CSI) feedback may be referred to as normal resolution CSI and normal resolution (CSI) feedback, respectively. Thus, in one or more embodiments of the present invention, “low resolution” may be referred to as “normal resolution.”

In one or more embodiments of the present invention, normal CSI may be CSI generated using the low resolution codebook and advanced CSI may be CSI generated using the high resolution codebook.

In one or more embodiments of the present invention, in a normal CSI feedback scheme, the normal CSI is reported from a user equipment (UE) to a base station (BS) as feedback information (normal CSI reporting). In one or more embodiments of the present invention, in an advanced CSI feedback scheme, the advanced CSI is reported from the UE to the BS as feedback information (advanced CSI reporting).

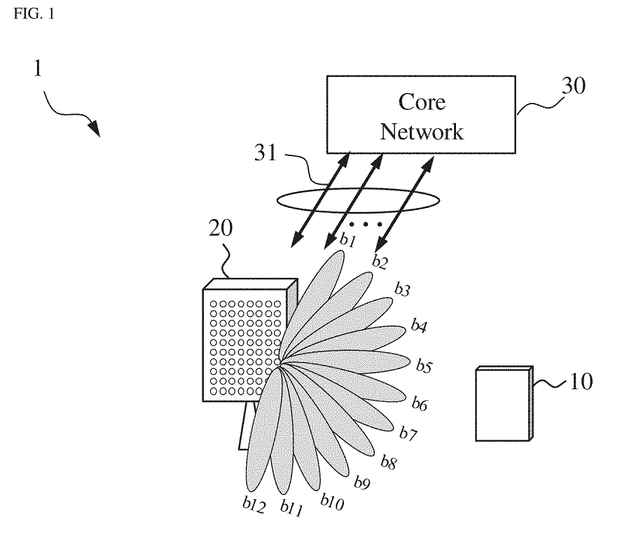

FIG. 1 is a wireless communications system 1 according to one or more embodiments of the present invention. The wireless communication system 1 includes a UE 10, a BS 20, and a core network 30. The wireless communication system 1 may be a New Radio (NR) system or an LTE/LTE-Advanced (LTE-A) system. The wireless communication system 1 is not limited to the specific configurations described herein and may be any type of wireless communication system.

The BS 20 may communicate uplink (UL) and downlink (DL) signals with the UE 10 in a cell of the BS 20. The DL and UL signals may include control information and user data. The BS 20 may communicate DL and UL signals with the core network 30 through backhaul links 31. The BS 20 may be an example of a base station (BS). The BS 20 may be referred to as a TRP. The BS 20 may be a gNodeB (gNB) for the NR system or an evolved NodeB (eNB) for the LTE/LTE-A system.

The BS 20 includes antennas, a communication interface to communicate with an adjacent BS 20 (for example, X2 interface), a communication interface to communicate with the core network 30 (for example, S1 interface), and a CPU (Central Processing Unit) such as a processor or a circuit to process transmitted and received signals with the UE 10. Operations of the BS 20 may be implemented by the processor processing or executing data and programs stored in a memory. However, the BS 20 is not limited to the hardware configuration set forth above and may be realized by other appropriate hardware configurations as understood by those of ordinary skill in the art. Numerous BSs 20 may be disposed so as to cover a broader service area of the wireless communication system 1.

The UE 10 may communicate DL and UL signals that include control information and user data with the BS 20 using Multi Input Multi Output (MIMO) technology. The UE 10 may be a mobile station, a smartphone, a cellular phone, a tablet, a mobile router, or information processing apparatus having a radio communication function such as a wearable device. The wireless communication system 1 may include one or more UEs 10.

The UE 10 includes a CPU such as a processor, a RAM (Random Access Memory), a flash memory, and a radio communication device to transmit/receive radio signals to/from the BS 20 and the UE 10. For example, operations of the UE 10 described below may be implemented by the CPU processing or executing data and programs stored in a memory. However, the UE 10 is not limited to the hardware configuration set forth above and may be configured with, e.g., a circuit to achieve the processing described below.

In one or more embodiments of the present invention, beam selection may be performed in the wireless communication system 1. For example, in a beam selection scheme, as shown in FIG. 1, the BS 20 may transmit multiple Channel State Information Reference Signals (CSI-RSs) using multiple beams b1-b12 to the UE 10. The UE 10 may perform channel estimation based on the received multiple CSI-RSs. Then, the UE 10 may select, from codebooks indicating candidates of precoding weights, at least a precoding weight. The UE 10 also selects at least beam based on a result of the channel estimation. The UE 10 may transmit, to the BS 20, feedback information including at least one of a Channel Quality Indicator(s) (RI(s)), a Precoding Matrix Indicator(s) (PMI(s)), a Rank Indicator(s) (RI(s)), and a CSI-RS Resource Index(es) (CRI(s)) (or Beam Index(es)). The CQI indicates channel quality state. The PMI indicates an index of the precoding weight(s). The RI indicates channel spatial freedom for DL transmission. The CRI identifies each of the beams. The UE 10 can report all the parameters or partial of the parameters, e.g., RI, PMI and CQI. The BS 20 may transmit a signal(s) precoded based on the feedback information to the UE 10. If the feedback information includes the CRI, the BS 20 may transmit the precoded signal(s) using the selected beam(s).

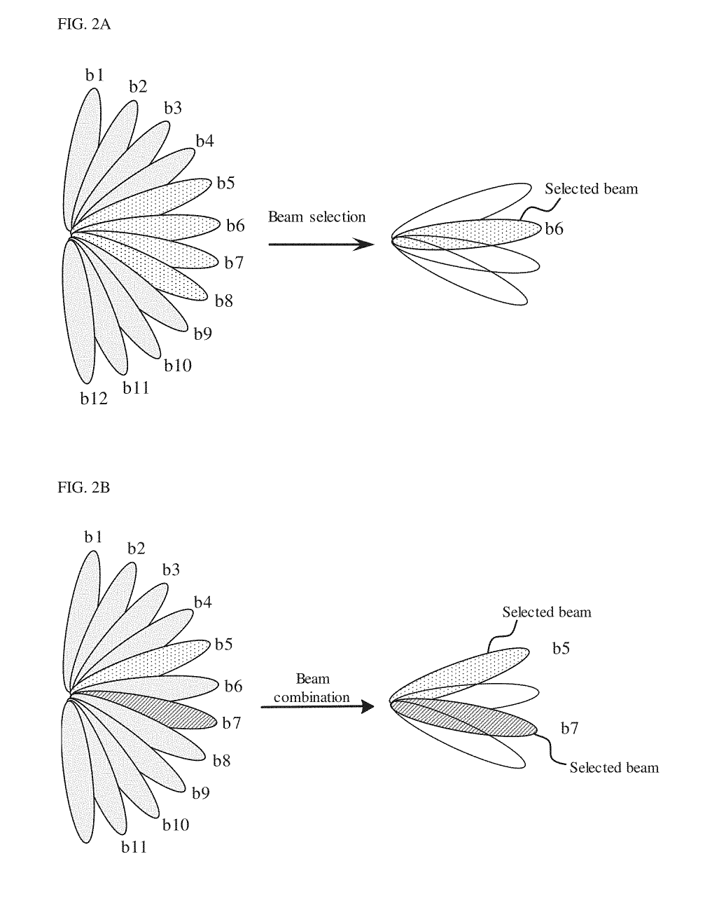

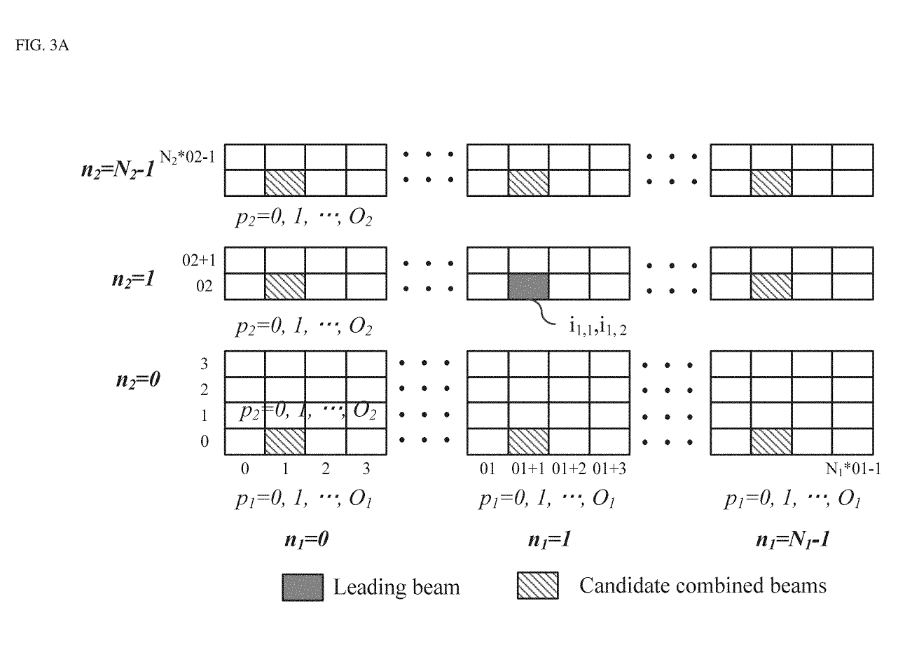

In one or more embodiments of the present invention, a low resolution codebook may be constructed based on a single beam selection scheme as shown in FIG. 2A. On the other hand, in one or more embodiments of the present invention, a high resolution codebook is constructed based on a beams combination scheme as shown in FIG. 2B. In an example of FIG. 2B, two beams b5 and b7 for a combination are selected in the beams combination scheme. In one or more embodiments of the present invention, a beam(s) used to construct the high resolution codebook is referred to as a high resolution beam(s).

(Codebook Design)

Methods of constructing the high resolution codebook according to one or more embodiments of the present invention will be described below. According to one or more embodiments of the present invention, the UE 10 may construct the high resolution codebook using a low resolution codebook. For example, the high resolution codebook may be constructed based on beam selection schemes for rank 2. The beam selection schemes for rank 2 includes an unconstrained beam selection scheme and a constrained beam selection scheme. The low resolution codebook may reuse beams selected based on a beam selection scheme under the LTE standard.

(Unconstrained Beam Selection Scheme)

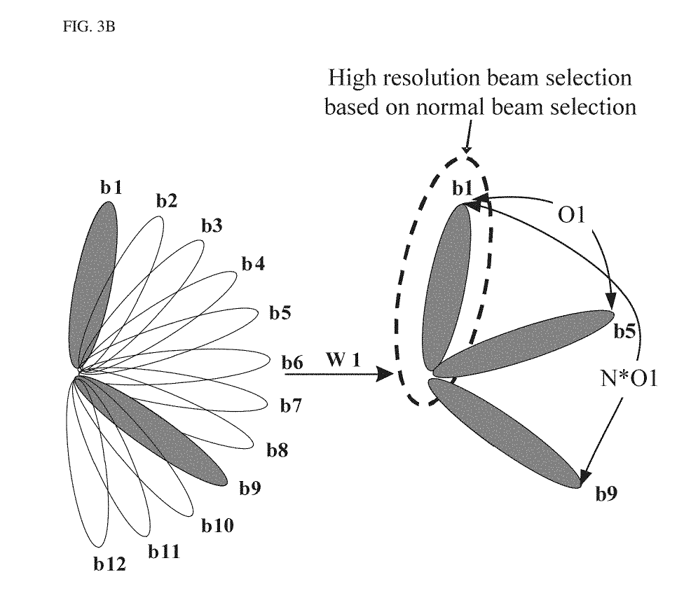

According to one or more embodiments of the present invention, the high resolution codebook may be constructed based on the unconstrained beam selection scheme for rank 2. As above, the high resolution beams including a leading beam and at least a combined beam are selected to construct the high resolution codebook. FIGS. 3A and 3B show an example of a method of selecting high resolution beams in accordance with the unconstrained beam selection scheme for rank 2 according to one or more embodiments of the present invention. In the unconstrained beam selection scheme, the high resolution codebook beam selection does not have group constrain.

FIG. 3A shows an example relating to an unconstrained beam combination by LTE Re1.13 rank 1 beams. As shown in FIG. 3A, each single grid represents one two-dimension (2D) Discrete Fourier Transform (DFT) vector indicating beam rotation. The DFT vector constitutes to a pre-coder used for beamforming. The whole grids represent all possible beams. In FIG. 3A, a horizontal axis and a vertical axis represent a horizontal direction and a vertical direction, respectively. O represents an oversampling factor. O₁ and O₂ indicate the oversampling factors in the horizontal direction and the vertical direction, respectively. N₁ and N₂ represent an antenna ports number in a first dimension and a second dimension, respectively. As those skilled in the art will readily appreciate, all of the specific dimensions can be changed without departing from the spirit of one or more embodiments of the present invention.

If a beam is at a distance of n₁*O₁+n₂*O₂(n₁=1, 2, . . . , N₁−1, n2=1, 2, . . . N₂−1) from the reference beam, the beam is orthogonal to the reference beam. All of the beams may be divided into N₁*N₂ beam groups. Each beam group is identified by index n₁, n₂. The size of one beam group is O₁*O₂. Another parameter p may be defined as an index of the DFT vector (beam rotation index) within a group. Thus, p1 is the DFT vector index in the first dimension and p₂ is the DFT vector index in the second dimension. In one beam group, each beam may be identified by p₁, p₂, p₁=0, 1, . . . O₁−1, p₂=0, 1, . . . O₂−1. The beam group is divided such that the beam p₁, p₂ in beam group a is orthogonal to the beam p₁, p₂ in beam group b.

Next, i_{1,1}, i_{1,2} in FIG. 3A may be defined to represent an absolute index of each beam in the entire grids. The definition of i_{1,1}, i_{1,2} can be found in 3GPP TS 36.213, Section 7.2.4, Table 7.2.4-10. i_{1,1}=p₁+n₁*O₁, i_{1,2}=p₂+n₂*O₂. The index of one beam may be represented by parameter p₁, p₂, n₁, n₂, O₁, O₂, N₁, N₂.

A high resolution beam construction process according to one or more embodiments of the present invention will be described below. In the LTE system, only one beam (e.g., i_{1,1}, i_{1,2}) is selected to construct a low resolution codebook for LTE. On the other hand, for high resolution feedback, K orthogonal beams may be selected to construct the high resolution codebook.

According to one or more embodiments of the present invention, among the K orthogonal beams, a leading beam may be selected according to a legacy codebook W1, which corresponds to the one beam for normal CSI reporting. As shown in FIG. 3A, the leading beam may be selected by i_{1,1}, and i_{1,2}, which can be derived by pₕ p₂ and n₁(1), n₂(1), that is, i_{1,1}(i)=p₁+n₁(i)*O₁ and i_{1,2}(i)=p₂+n₂(i)*O₂. The combined beams may be fixed by n₁(k), n₂(k), k∈{2, . . . , K}, where K is the total number of combined beams, which indicates which the orthogonal beam is selected. In an example of FIG. 3B, when the candidate combined beams are beams b1 and b9, beam b5 is selected as the leading beam using the legacy codebook W1.

In order to reuse the legacy codebook W1 and the legacy feedback scheme, the definition of i_{1,1}, i_{1,2} are identical to those used for legacy codebook, e.g., in 3GPP TS 36.213, Section 7.2.4, Table 7.2.4−10. The other K−1 candidate combined beams are those at distance of n₁*O₁+n₂*O₂.

In a CSI feedback scheme, the normal CSI includes the RI, a leading beam index and the CQI. On the other hand, in one or more embodiments of the present invention, an advanced CSI includes, in addition to the normal CSI, K−1 combined beam indexes, the amplitude and co-phase of the combined beams, if any. Advanced CSI reporting includes the RI and the CQI. For advanced CSI reporting, index of the combined beam k be n₁(k), n₂(k) instead of i_{1,1}(k), i_{1,2}(k) to reduce feedback overhead.

For a beam index encoding scheme according to one or more embodiments of the present invention, the leading beam index and the combined beam index may be determined based on joint coding of the DFT vector index (rotation index). For example, the leading beam index may be determined as i_{1,1}(1)=p₁+n₁(1)*O₁, i_{1,2}(1)=p₂+n₂(1)*O₂. The combined beam index may be determined as n₁(2), n₂(2), . . . n₁(K), n₂(K), where K is the total number of beams. In the BS 20, it can infer the combined beam index by: i_{1,1}(k)=mod(i_{1,1}(1), O₁)+n₁(k)*O₁ and i_{1,2}(k)=mod(i_{1,2}(1), O₂)+n₂(k)*O₂. Thus, feedback of the leading beam index can be performed based on the legacy LTE codebook and can reuse the legacy LTE feedback, because the definition of i_{1,1}(1) and i_{1,2}(1) is identical to those defined for the legacy LTE feedback of a 1-layer codebook, as seen in 3GPP TS 36.213, Section 7.2.4, Table 7.2.4-10.

As another example of the beam index encoding scheme, the independent DFT vector index (rotation index) may be determined as p₁, p₂ and the beam index for each beam may be determined as n₁(1), n₂(1) [leading beam], n₁(2), n₂(2), . . . , n₁(K), n₂(K). In the BS 20, it can infer the combined beam index by: i_{1,1}(k)=p₁+n₁(k)*O₁ and i_{1,2}(k)=p₂+n₂(k)*O₂.

If the advanced CSI reporting is configured, additional information will be reporting. The additional beam index and weightings are scaled refer to the leading beam reported in the normal CSI reporting. If there is no additional information, the BS 20 will use normal CSI feedback.

Thus, according to one or more embodiments of the present invention, the high resolution beams reuses the LTE rank 1 beams and the orthogonal beams are selected as the high resolution beams. The high resolution codebook reuses the rank 1 beam selection scheme when the rank 1 beam selection scheme has no group constrain.

(Constrained Beam Selection Scheme)

According to one or more embodiments of the present invention, the high resolution codebook may be constructed based on the constrained beam selection scheme for rank 2 and reuse beam selection scheme of LTE with higher rank. The constrained beam selection scheme for Rank 2 includes two, three, and four beams combination schemes. In the constrained beam selection scheme, the high resolution codebook beam selection has group constrain.

Furthermore, the BS 20 may receive the normal CSI feedback in an earlier (predetermined) time instance. The BS 20 may receive the advanced CSI feedback in a first part in an earlier time instance as part of the normal CSI feedback, and in a second part with additional feedback information.

(Two Beams Combination Scheme)

In the two beams combination scheme, when a legacy LTE 3-layer codebook (rank 3/4 codebook) is used for the normal CSI, the high resolution CSI codebook is constructed via the same beam group with the two beams combination for each layer. In the two beams combination scheme, amplitude and phase are added for combined beams. The LTE 3-layer codebook is defined in 3GPP TS 36.213, Section 7.2.4, Table 7.2.4-12.

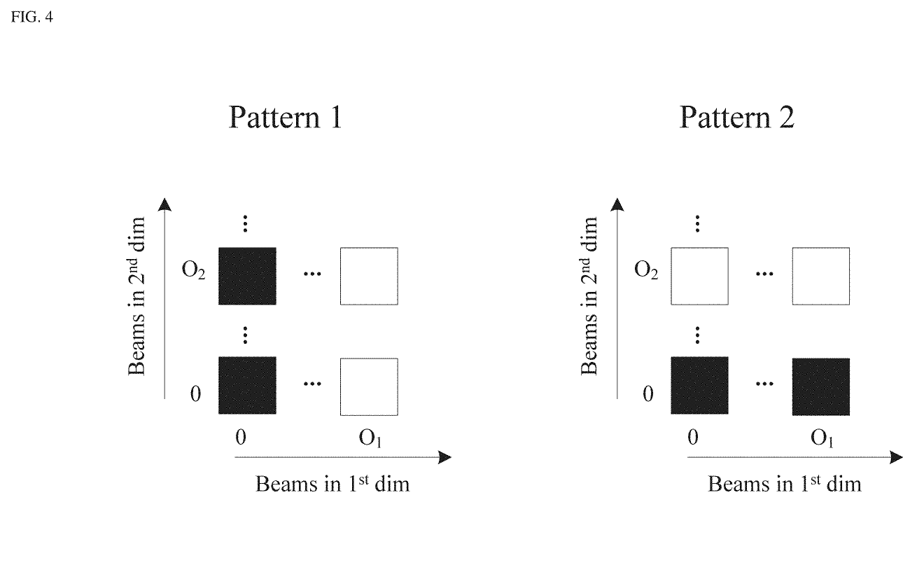

FIG. 4 is a diagram showing an example relating to candidate beam patterns for two beams combination for each layer. In the two beams combination scheme, for each layer, the combined beam and the leading beam have a fixed spacing, and the spacing may comply with the 3-layer codebook.

As shown in FIG. 4, a pattern 1 shows that the combined beam and the leading beam have a spacing of O₂. In FIG. 4, a pattern 2 shows that the combined beam and the leading beam has a spacing of O₁.

The beam pattern may be determined by the legacy beam index i′_{1,1} and i′_{1,2}, which means that if floor(i′_{1,1}/(N₁*O₁))=0, the pattern 2 is selected and if floor(i′_{1,1}/(N₁*O₁))=1, the pattern 1 is selected.

In the beam patterns for the two beams combination for each layer, the legacy codebook W1 may be constructed based on the following formula:

$${w}_{1} = [ \begin{matrix}{a}_{1} {b}_{1} {a}_{2} {b}_{2} & 0 \\ 0 & {a}_{1} {b}_{1} {a}_{2} {b}_{2}\end{matrix} ]$$

In the beam patterns for the two beams combination for each layer, the codebook W2 may be constructed based on the following formula:

$${w}_{2} = [ \begin{matrix}\begin{matrix}[ \begin{matrix}1 \\ {θ}_{1}\end{matrix} ] \\ ϕ [ \begin{matrix}1 \\ {θ}_{1}\end{matrix} ]\end{matrix} & θ [ \begin{matrix}[ \begin{matrix}1 \\ {θ}_{1}\end{matrix} ] \\ ϕ [ \begin{matrix}1 \\ {θ}_{1}\end{matrix} ]\end{matrix} ]\end{matrix} ] ,$$

where φ is the co-phase for two polarizations, θ is the co-phase for two layers, θᵢ represents the phase for ith combined beams for each layer (i=1, 2, . . . , L−1, L), L is the total number of combined beams, and L=2/3/4. For rank 3-8, φ is a constant value.

(Three Beams Combination Scheme)

In the three beams combination scheme, when a LTE 5-layer codebook (rank 5/6 codebook) is used for the normal CSI, the high resolution CSI codebook is constructed via the same beam group with the three beams combination for each layer. In the three beams combination scheme, amplitude and phase are added for combined beams. The LTE 5-layer codebook is defined in 3GPP TS 36.213, Section 7.2.4, Table 7.2.4-14.

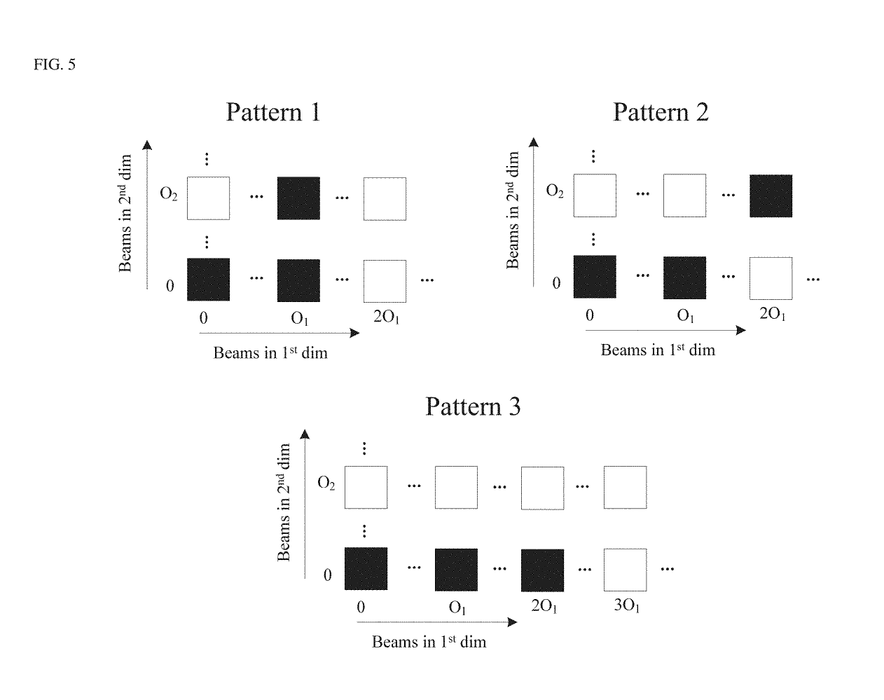

FIG. 5 is a diagram showing an example relating to candidate beam patterns for three beams combination for each layer. In the three beams combination scheme, for each layer, the combined beams and the leading beam have fixed spacing, and the spacing may comply with the legacy LTE 5-layer codebook. The pattern may be selected based on a configuration of higher layer signaling in the legacy codebook.

In the high resolution codebook, the beam pattern for one-dimensional (1D) antenna layout may be determined by the parameters (N₁, N₂).

The beam pattern for two-dimensional (2D) antenna layout may be configured by higher layer signaling indication, DCI dynamic indication, or UE selected manner together with the leading beam selection, i.e., beam index (i_{1,1}, i_{1,2}) selection.

Although the beam pattern is indicated in LTE Re1.13, it can be UE recommended in high resolution CSI reporting. By the UE recommended manner, in three beams combination case, the UE 10 selects one pattern from the three patterns (patterns 1, 2, and 3) for 2D antenna layouts, which take 1 bit to inform the BS 20.

In the beam patterns for the three beams combination for each layer, the legacy codebook W1 may be constructed based on the following formula:

$${w}_{1} = [ \begin{matrix}{a}_{1} {b}_{1} {a}_{2} {b}_{2} {a}_{3} {b}_{3} & 0 \\ 0 & {a}_{1} {b}_{1} {a}_{2} {b}_{2} {a}_{3} {b}_{3}\end{matrix} ]$$

In the beam patterns for the three beams combination for each layer, the codebook W2 may be constructed based on the following formula:

$${w}_{2} = [ \begin{matrix}\begin{matrix}[ \begin{matrix}1 \\ {θ}_{2} \\ {θ}_{3}\end{matrix} ] \\ ϕ [ \begin{matrix}1 \\ {θ}_{2} \\ {θ}_{3}\end{matrix} ]\end{matrix} & θ [ \begin{matrix}[ \begin{matrix}1 \\ {θ}_{2} \\ {θ}_{3}\end{matrix} ] \\ ϕ [ \begin{matrix}1 \\ {θ}_{2} \\ {θ}_{3}\end{matrix} ]\end{matrix} ]\end{matrix} ]$$

(Four Beams Combination Scheme)

In the four beams combination scheme, when a LTE 7-layer codebook (rank 7/8 codebook) is used for the normal CSI, the high resolution CSI codebook is constructed via the same beam group with the four beams combination for each layer. In the four beams combination scheme, amplitude and phase are added for combined beams. The LTE 7-layer codebook is defined in 3GPP TS 36.213, Section 7.2.4, Table 7.2.4-16.

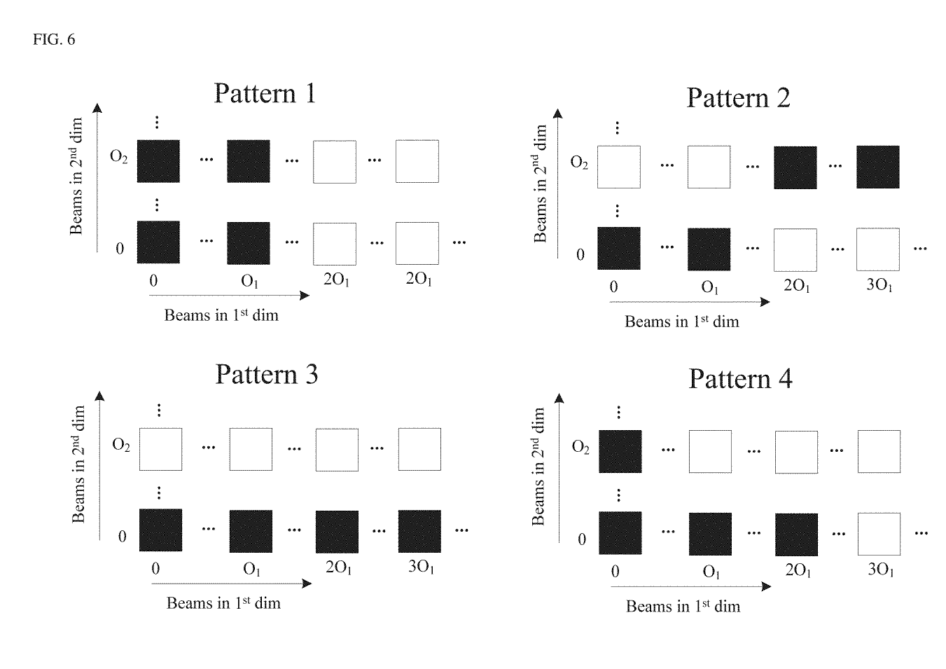

FIG. 6 is a diagram showing an example relating to candidate beam patterns for four beams combination for each layer. In the four beams combination scheme, for each layer, the combined beams and the leading beam have fixed spacing, and the spacing may comply with the legacy LTE 7-layer codebook. The pattern may be selected according to the configuration of higher layer signaling in the legacy codebook.

The beam and pattern selection procedure for four beams combination scheme are the same as three beams combination scheme. That is, the leading beam is selected by the beam index (i_{1,1}, i_{1,2}). The beam pattern for 1D antenna layout may be determined by the parameters (N₁, N₂).

The beam pattern for 2D antenna layout may be configured by higher layer signaling indication, DCI dynamic indication, or UE selected manner together with the leading beam selection. By the UE recommended manner, in four beams combination case, the UE selects one pattern from the four patterns (patterns 1-4) for 2D antenna layouts, which take 2 bits to inform the eNB.

In the beam patterns for the four beams combination for each layer, the legacy codebook W1 may be constructed based on the following formula:

$${w}_{1} = [ \begin{matrix}{a}_{1} {b}_{1} {a}_{2} {b}_{2} {a}_{3} {b}_{3} {a}_{4} {b}_{4} & 0 \\ 0 & {a}_{1} {b}_{1} {a}_{2} {b}_{2} {a}_{3} {b}_{3} {a}_{4} {b}_{4}\end{matrix} ]$$

In the beam patterns for the three beams combination for each layer, the codebook W2 may be constructed based on the following formula:

$${w}_{2} = [ \begin{matrix}\begin{matrix}[ \begin{matrix}1 \\ {θ}_{2} \\ {θ}_{3} \\ {θ}_{4}\end{matrix} ] \\ ϕ [ \begin{matrix}1 \\ {θ}_{2} \\ {θ}_{3} \\ {θ}_{4}\end{matrix} ]\end{matrix} & θ [ \begin{matrix}[ \begin{matrix}1 \\ {θ}_{2} \\ {θ}_{3} \\ {θ}_{4}\end{matrix} ] \\ ϕ [ \begin{matrix}1 \\ {θ}_{2} \\ {θ}_{3} \\ {θ}_{4}\end{matrix} ]\end{matrix} ]\end{matrix} ]$$

(CSI Feedback Design)

A feedback scheme according to one or more embodiments of the present invention comprise a hierarchical feedback framework to support normal CSI feedback and advanced CSI feedback as a CSI feedback type. The normal CSI feedback and the advanced CSI feedback have different feedback delays.

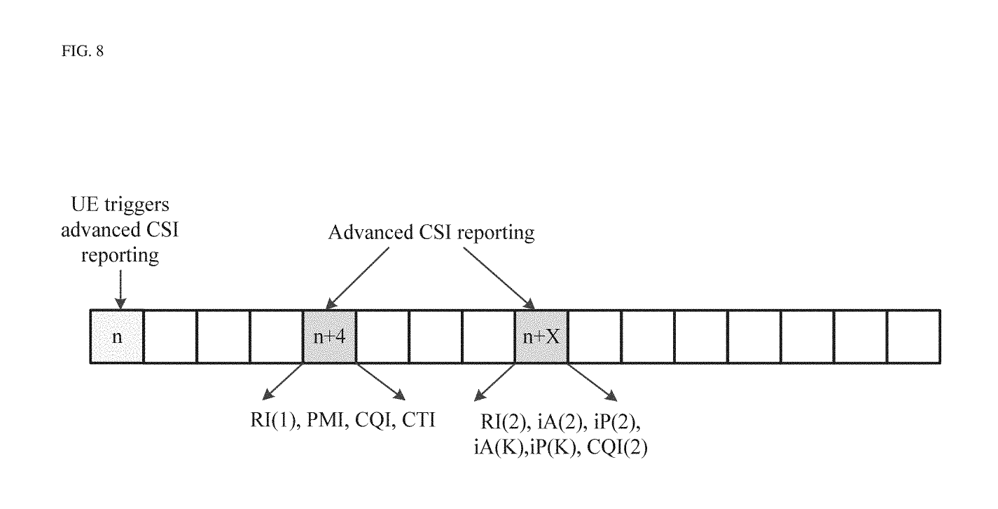

FIG. 8 shows an example of the advanced CSI reporting triggered by the BS 20 using the RRC signaling or DCI. In FIG. 8, when the UE 10 receives a trigger of the advanced CSI reporting on subframe “n,” the advanced CSI reporting may be performed on subframes “n+4” and “n+X.”

If the normal CSI is selected, RI(1) indicates the suggested transmission layers as it directly interpreted, additional information such as no additional RI(2) and iA and iP may not be needed to be reported.

If the advanced CSI is selected, additional CSI information, e.g., RI(2), iA, iP, and CQI(2) will be reported, in this case, the CSI reporting parameter RI(1) indicates the suggested beams for combination, and RI(2) indicates the real suggested transmission layers.

FIG. 9 shows an example where the CSI feedback type is selected by the UE 10.

In the normal CSI reporting, the UE 10 may report RI, PMI1, and CSI Type Indicator (CTI) to the BS 20. The value of RI may be 0-7 to indicate the present used codebook.

If the advanced CSI reporting is configured (or selected by CTI), the advanced CSI reporting includes additional information such as RI, amplitude for combined beams, co-phase for two polarizations, co-phase for two layers, and phase for combined beams. For example, if the advanced CSI reporting is selected by CTI, the normal CSI feedback may include presence of additional feedback information.

One or more embodiments of the present invention may include one or more of the following advantages.

One or more embodiments of the present invention describe one way to construct codebook for channel matrix or precoder feedback. The codebook has a nested structure which can be used for channel quantization with multiple resolutions. Such a codebook design enables flexible tradeoff between channel quantization accuracy and feedback overhead. As the low resolution codebook part is built based on the legacy codebook, it fully follows the legacy feedback framework, and it achieves a good compatibility with the legacy UE, which can only support legacy codebook.

One or more embodiments of the present invention relate a hierarchical feedback framework to support normal CSI feedback and advanced CSI feedback. The feedback framework can support flexible tradeoff between channel feedback accuracy, feedback overhead and latency.

One or more embodiments of the present invention may avoid poor performance by low resolution feedback. One or more embodiments of the present invention may avoid unnecessary feedback overhead incurred by high resolution feedback. One or more embodiments of the present invention may avoid unnecessary channel feedback accuracy degradation caused by high resolution feedback calculation. One or more embodiments of the present invention may be used for eNB to obtain reliable channel state information to optimize beamforming and Multi-Input Multi-Output (MIMO) (e.g., SU-MIMO or MU-MIMO) to provide high data rate, high reliability service.

One or more embodiments of the present invention may differ in the way to construct codebook. That is, previous methods focus on designing new codebook for advanced CSI reporting, which is not compatible to the legacy LTE codebook, or reusing legacy codebook, with either non-orthogonal or constrained DFT beams. One or more embodiments of the present invention provide the way to construct high resolution beam by reusing legacy codebook of LTE. Besides, beams can be both constrained and unconstrained, orthogonal or non-orthogonal. Another difference of one or more embodiments of the present invention is the design of adaptive reporting type indication.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A method of constructing a codebook with multiple resolution in a wireless communication system comprising:
constructing, with a user equipment (UE), a high resolution codebook using a low resolution codebook; and
transmitting, from the UE to a base station (BS), normal Channel State Information (CSI) feedback or advanced CSI feedback based on an instruction from the BS or determination in the UE,
wherein the normal CSI feedback includes CSI generated based on the low resolution codebook, and
wherein the advanced CSI feedback includes CSI generated based on the high resolution codebook.

2. The method according to claim 1, wherein the low resolution codebook reuses beams selected based on a beam selection scheme under a Long Term Evolution (LTE) standard.

3. The method according to claim 1,
wherein the high resolution codebook is a high resolution codebook for rank 2, and
wherein the high resolution codebook reuses a 1-layer codebook of a LTE standard.

4. The method according to claim 1,
wherein the high resolution codebook is a high resolution codebook for rank 2, and
wherein the high resolution codebook reuses 3-layer, 5-layer, or 7-layer codebook of a LTE standard.

5. The method according to claim 1, wherein a beam selection scheme to construct the high resolution codebook has group constrain.

6. The method according to claim 1, wherein the normal CSI feedback and the advanced CSI feedback have different feedback delays.

7. The method according to claim 1, further comprising;
transmitting, from the BS to the UE, the instruction that designates the normal CSI feedback or the advanced CSI feedback.

8. The method according to claim 1, further comprising;
wherein when the UE determines the normal CSI feedback or the advanced CSI feedback, the normal CSI feedback or the advanced CSI feedback includes a CSI reporting type that indicates whether CSI feedback is the normal CSI feedback or the advanced CSI feedback.

9. The method according to claim 6, further comprising;
receiving, with the BS, normal CSI feedback in a predetermined time instance.

10. The method according to claim 1, further comprising:
receiving, with the BS, the advanced CSI feedback in a first part in a predetermined time instance as part of the normal CSI feedback, and in a second part with additional feedback information.

11. The method according to claim 8, wherein the normal CSI feedback includes presence of additional feedback information.

12. The method according to claim 1, further comprising:
selecting, with the UE, high resolution beams including a leading beam and at least a combined beam,
wherein the constructing constructs the high resolution codebook based on the selected high resolution beams, and
wherein the high resolution codebook is a high resolution codebook for rank 2.

13. The method according to claim 12, wherein the high resolution beams are orthogonal to each other.

14. The method according to claim 12, wherein the selecting selects the high resolution beams based on a 1-layer codebook of a LTE standard.

15. The method according to claim 12,
wherein when a number of the combined beams is less than or equal to 4, the selecting selects the high resolution beam based on a 3-layer codebook of a LTE standard, and
wherein the leading beam and the combined beams have a fixed spacing.

16. The method according to claim 12,
wherein when a number of the combined beams is less than or equal to 6, the selecting selects the high resolution beam based on a 5-layer codebook of a LTE standard, and
wherein the leading beam and the combined beams have a fixed spacing.

17. The method according to claim 12,
wherein when a number of the combined beams is less than or equal to 8, the selecting selects the high resolution beam based on a 7-layer codebook of a LTE standard, and
wherein the leading beam and the combined beams have a fixed spacing.

18. A user equipment (UE) comprising:
a processor that constructs a high resolution codebook using a low resolution codebook; and
a transmitter that transmits, to a base station (BS), normal Channel State Information (CSI) feedback or advanced CSI feedback based on an instruction from the BS or determination in the UE,
wherein the normal CSI feedback includes CSI generated based on the low resolution codebook, and
wherein the advanced CSI feedback includes CSI generated based on the high resolution codebook.

19. The UE according to claim 18,
wherein the high resolution codebook is a high resolution codebook for rank 2, and
wherein the high resolution codebook reuses a 1-layer codebook of a LTE standard.

20. The UE according to claim 18,
wherein the high resolution codebook is a high resolution codebook for rank 2, and
wherein the high resolution codebook reuses 3-layer, 5-layer, or 7-layer codebook of a LTE standard.
